(19) United States
(12) Patent Application Publication
(10) Pub. No.: US 2025/0321093 A1
(43) Pub. Date: Oct. 16, 2025

(54) OPTICAL ALIGNMENT DETECTION APPARATUS AND OPTICAL ALIGNMENT DETECTION METHOD

(71) Applicants: National Central University, Taoyuan City (TW); USUN TECHNOLOGY CO., LTD, Taoyuan City (TW)

(72) Inventors: Ju-Yi Lee, Taipei City (TW); Wei-Chen Wong, New Taipei City (TW); Hsing-Hsien Tsai, Taoyuan City (TW)

(21) Appl. No.: 18/925,087

(22) Filed: Oct. 24, 2024

(30) Foreign Application Priority Data
Apr. 16, 2024 (TW) 113114177

(51) Int. Cl. G01B 11/27; G02B 5/30

(52) U.S. Cl. CPC G01B 11/272; G02B 5/3025; G02B 5/3083

(57) ABSTRACT

An optical alignment detection apparatus is adapted to detect a wave plate to be detected. The optical alignment detection apparatus includes a light source system, a first linear polarizer, a second linear polarizer, and an optical detector. The wave plate to be detected is rotatably disposed between the first linear polarizer and the second linear polarizer. The beam is converted into an alignment beam through the first linear polarizer, the wave plate to be detected, and the second linear polarizer, and is received by the optical detector. When the wave plate to be detected rotates, an intensity of the alignment beam received by the optical detector would change periodically. An angle of an optical axis between the wave plate to be detected and the second linear polarizer can be judged according to the periodical change of the intensity of the beam, so as to achieve precise alignment.

### FIELD OF THE INVENTION

The present invention provides an optical detection technology, particularly an optical alignment detection apparatus and an optical alignment detection method for combining a circular polarizer.

### BACKGROUND OF THE INVENTION

With the progress of science, the requirement on optical products is higher in modern life. In order to provide a more excellent quality visually, optical elements such as a compensation film or a composite polarizer are applied to products such as an optical lens filter, 3D glasses or a display screen to achieve the purpose of adjusting the chromatic aberration or the 3D effect. The compensation film or the composite polarizer is formed by attaching at least one linear polarizer and at least one wave plate. According to the principle of optics, a beam passing through the linear polarizer would form linearly polarized light, and attached to the wave plate, the fast axis and the slow axis of the beam generate a phase difference to further achieve the purpose of adjusting the chromatic aberration or the 3D effect. Therefore, to improve the accuracy of alignment of the linear polarizer and the wave plate contributes to improving the quality of the optical element, so that the optical product can represent a more real colored image or a wide 3D image.

### SUMMARY OF THE INVENTION

The present invention provides an optical alignment detection apparatus and an optical alignment detection method. Linearly polarized light is transmitted to a rotating wave plate to be detected and a fixed linear polarizer to generate beams with different intensities for optical alignment detection, so that the wave plate to be detected and the linear polarizer acquire appropriate polarized light angle and direction.

The optical alignment detection apparatus provided by the present invention is adapted to detect a wave plate to be detected. The optical alignment detection apparatus includes a light source system, a first linear polarizer, a second linear polarizer, and an optical detector. A light source system is adapted to project a beam. The first linear polarizer is disposed on a side of the light source system and located on a transmission path of the beam, the beam being converted into linearly polarized light by the first linear polarizer. The second linear polarizer is disposed on a side of the first linear polarizer away from the light source system, and the wave plate to be detected is adapted to be rotatably disposed between the first linear polarizer and the second linear polarizer, wherein the linearly polarized light is transmitted to the wave plate to be detected and the second linear polarizer and is converted into an alignment beam. The optical detector is disposed on a side of the second linear polarizer away from the first linear polarizer, and receives the alignment beam, and records and analyzes the intensity of the alignment beam when the wave plate to be detected is located at different rotation angles, wherein when the intensity of the alignment beam is a maximum value or a minimum value, the wave plate to be detected at the rotation angle is located at an aligned position.

In an embodiment of the present invention, the beam is a laser. In an embodiment of the present invention, the optical detector has a polarization interference dephasing system.

In an embodiment of the present invention, the wave plate to be detected rotates by taking a center axis as an axis, and the center axis passes through and is perpendicular to the first linear polarizer and the second linear polarizer.

The present invention provides an optical alignment detection method, adapted to detect a wave plate to be detected. The optical alignment detection method includes: projecting a beam by using a light source system; disposing a first linear polarizer on a side of the light source system and converting the beam into linearly polarized light by the first linear polarizer; disposing a second linear polarizer on a side of the first linear polarizer away from the light source system, the wave plate to be detected being adapted to be rotatably disposed between the first linear polarizer and the second linear polarizer, wherein the linearly polarized light is transmitted to the wave plate to be detected and the second linear polarizer and is converted into an alignment beam, and the alignment beam has different intensities as the wave plate to be detected is located at different rotation angles; and disposing an optical detector on a side of the second linear polarizer away from the first linear polarizer, receiving the alignment beam by the optical detector and recording and analyzing the intensities of the alignment beam when the wave plate to be detected is located at different rotation angles, wherein when the intensity of the alignment beam is a maximum value or a minimum value, the wave plate to be detected at the rotation angle is located at an aligned position.

In an embodiment of the present invention, the wave plate to be detected is a quarter-wave plate.

In an embodiment of the present invention, the wave plate to be detected rotates by taking a center axis as an axis, and the center axis passes through and is perpendicular to the first linear polarizer and the second linear polarizer.

In an embodiment of the present invention, prior to disposing the wave plate to be detected between the first linear polarizer and the second linear polarizer, the method further includes a correcting step, the correcting step including: projecting the beam by using the light source system, the beam transmitted to the first linear polarizer and the second linear polarizer in order and converted into a correction beam, wherein the second linear polarizer rotates by taking the center axis as an axis and the correction beam has different intensities as the rotation angles of the second linear polarizer are different; and receiving, by the optical detector, the correction beam, and recording and analyzing, by the optical detector, the intensities of the correction beam when the second linear polarizer is located at different rotation angles, wherein when the intensity of the correction beam is a maximum value or a minimum value, the second linear polarizer at the rotation angle is located at a corrected position.

In an embodiment of the present invention, when the wave plate to be detected is disposed between the first linear polarizer and the second linear polarizer, the second linear polarizer is positioned at the corrected position.

In an embodiment of the present invention, the first linear polarizer has a first transmission axis, the second linear polarizer has a second transmission axis, and the correcting step refers to rotating the second linear polarizer to make an included angle between the first transmission axis and the second transmission axis be 0 degrees or 90 degrees.

In an embodiment of the present invention, the wave plate to be detected has a fast axis; and when the intensity of the alignment beam is the maximum value or the minimum value, an included angle between the fast axis of the wave plate to be detected and the second transmission axis is one of 45 degrees, 135 degrees, 225 degrees or 315 degrees.

The beam projected by the light source system is converted into the linearly polarized light by using the first linear polarizer, so that the intensity change of the alignment beam passing through the wave plate to be detected and the second linear polarizer is more obvious than that using a conventional elliptic polarizer or a circular polarizer, so that the alignment accuracy of the wave plate to be detected and the second linear polarizer is improved.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of an optical alignment detection apparatus in an embodiment of the present invention.

FIG. 2 is a flowchart of an optical alignment detection method in an embodiment of the present invention.

FIG. 3 is a correcting schematic diagram of the optical alignment detection method in an embodiment of the present invention.

FIG. 4 is an aligning schematic diagram of the optical alignment detection apparatus in an embodiment of the present invention.

FIG. 5 is an intensity change diagram of an alignment beam in an alignment process in the optical alignment detection method in an embodiment of the present invention.

FIG. 6 is a correcting schematic diagram of an optical alignment detection method in another embodiment of the present invention.

FIG. 7 is an aligning schematic diagram of the optical alignment detection apparatus in another embodiment of the present invention.

FIG. 8 is an intensity change diagram of an alignment beam in an alignment process in the optical alignment detection method in another embodiment of the present invention.

### DETAILED DESCRIPTION OF PREFERRED EMBODIMENTS

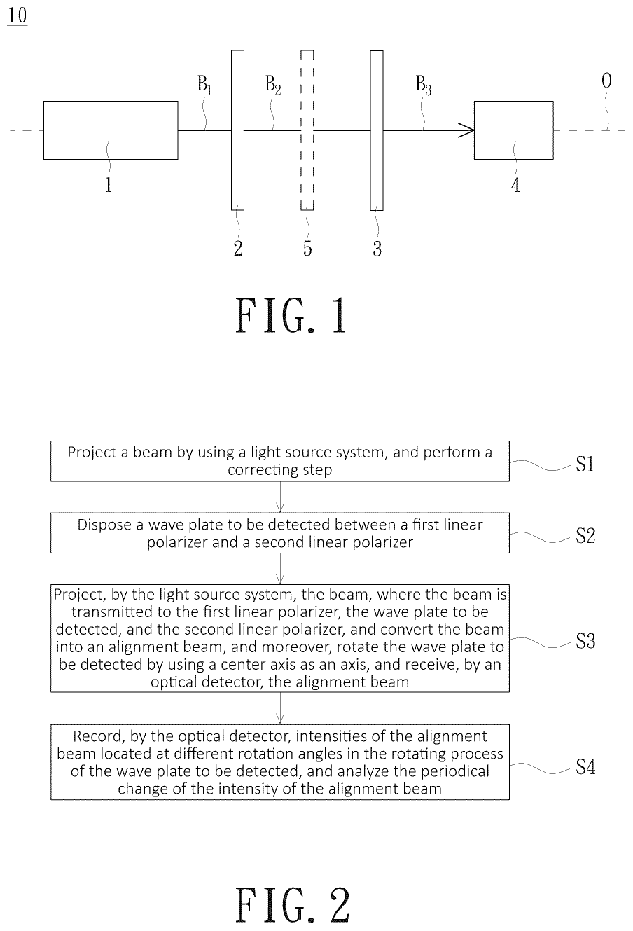

FIG. 1 is a schematic diagram of an optical alignment detection apparatus in an embodiment of the present invention. As shown in FIG. 1, the optical alignment detection apparatus 10 is adapted to detect a wave plate to be detected 5. The optical alignment detection apparatus 10 includes a light source system 1, a first linear polarizer 2, a second linear polarizer 3, and an optical detector 4. The light source system 1 is adapted to project a beam B₁, which is, for example, a laser, and in a transmission path direction of the beam B₁, the first linear polarizer 2, the second linear polarizer 3, and the optical detector 4 are disposed in order. Specifically, the first linear polarizer 2 is disposed on a side of the light source system 1 and is located on a transmission path of the beam B₁, and the beam B₁ is converted into linearly polarized light B₂ by the first linear polarizer 2; the second linear polarizer 3 is disposed on a side of the first linear polarizer 2 away from the light source system 1, and the wave plate to be detected 5 is rotatably disposed between the first linear polarizer 2 and the second linear polarizer 3, wherein the linearly polarized light B₂ is transmitted to the wave plate to be detected 5 and the second linear polarizer 3 and is converted into an alignment beam B₃; the optical detector 4 is disposed on a side of the second linear polarizer 3 away from the first linear polarizer 2, and is adapted to receive the alignment beam B₃ and to record and analyze an intensity of the alignment beam B₃; and in an embodiment, the optical detector 4 includes a polarization interference dephasing system.

A center axis O which is perpendicular to the first linear polarizer and the second linear polarizer 3 is defined, and the wave plate to be detected 5 rotates by taking the center axis O as an axis.

FIG. 2 is a flowchart of an optical alignment detection method in an embodiment of the present invention. The optical alignment detection method is adapted to optically align the wave plate to be detected 5 and the second linear polarizer 3 by virtue of the optical alignment detection apparatus 10. Configurations of the light source system 1, the first linear polarizer 2, the second linear polarizer 3, and the optical detector 4 included in the optical alignment detection apparatus 10 are revealed in FIG. 1 and the description, which are not repeatedly described herein.

Referring to FIG. 1 and FIG. 2 together, the optical alignment detection method includes the following steps: step S1, projecting the beam B₁ by using the light source system 1, and selectively performing a correcting step by using the beam B₁ to fix an included angle θ₁ between a first transmission axis A₁ of the first linear polarizer 2 and a second transmission axis A₂ of the second linear polarizer 3, as a basis for subsequent alignment of the wave plate to be detected 5 and the second linear polarizer 3;

then, step S2, disposing the wave plate to be detected 5 between the first linear polarizer 2 and the second linear polarizer 3; and then step S3, projecting, by the light source system 1, the beam B₁, wherein the beam B₁ is transmitted to the first linear polarizer 2, the wave plate to be detected 5, and the second linear polarizer 3 in order and is converted into an alignment beam B₃, wherein the beam B₁ is converted into linearly polarized beam B₂ by the first linear polarizer 2 and is then transmitted to the wave plate to be detected 5 and the second linear polarizer 3; in step S3, the wave plate to be detected 5 rotates by taking the center axis O as the axis, and in the rotating process of the wave plate to be detected 5, the optical detector 4 receives the alignment beam B₃, and as the wave plate to be detected 5 is located at different rotation angles, the alignment beam B₃ has a change on intensity. In an embodiment, the alignment beam B₃ has, for example, a periodical intensity change.

Then, in step S4, the optical detector 4 records the intensities of the alignment beam B₃ located at different rotation angles in the rotating process of the wave plate to be detected 5, and analyzes the periodical change of the intensity of the alignment beam B₃. When the intensity of the alignment beam B₃ is the maximum value or the minimum value, the wave plate to be detected 5 at the rotation angle is located at an aligned position. Subsequently, the wave plate to be detected 5 finally stopped at the aligned position and the second linear polarizer 3 are attached to serve as the circular polarizer. For example, when the wave plate to be detected 5 is a quarter-wave plate, the wave plate to be detected 5 is at the aligned position, indicating that an included angle θ₂ between a fast axis of the wave plate to be detected 5 and the second transmission axis A₂ of the second linear polarizer 3 is one of 45 degrees, 135 degrees, 225 degrees or 315 degrees. In an embodiment, step S3 and step S4 can be performed simultaneously; that is, the optical detector 4 analyzes the periodical change of the intensity of the alignment beam B₃ while receiving the alignment beam B₃.

Whether the intensity of the alignment beam B₃ the maximum value or the minimum value as the basis that the wave plate to be detected 5 is located at the aligned position is determined by the size of the included angle θ₁ between the first transmission axis A₁ and the second transmission axis A₂ obtained in the correcting step. In an embodiment, whether the first transmission axis A₁ and the second transmission axis A₂ are orthogonal can be taken as a selection basis to determine whether the intensity is the maximum value or the minimum value.

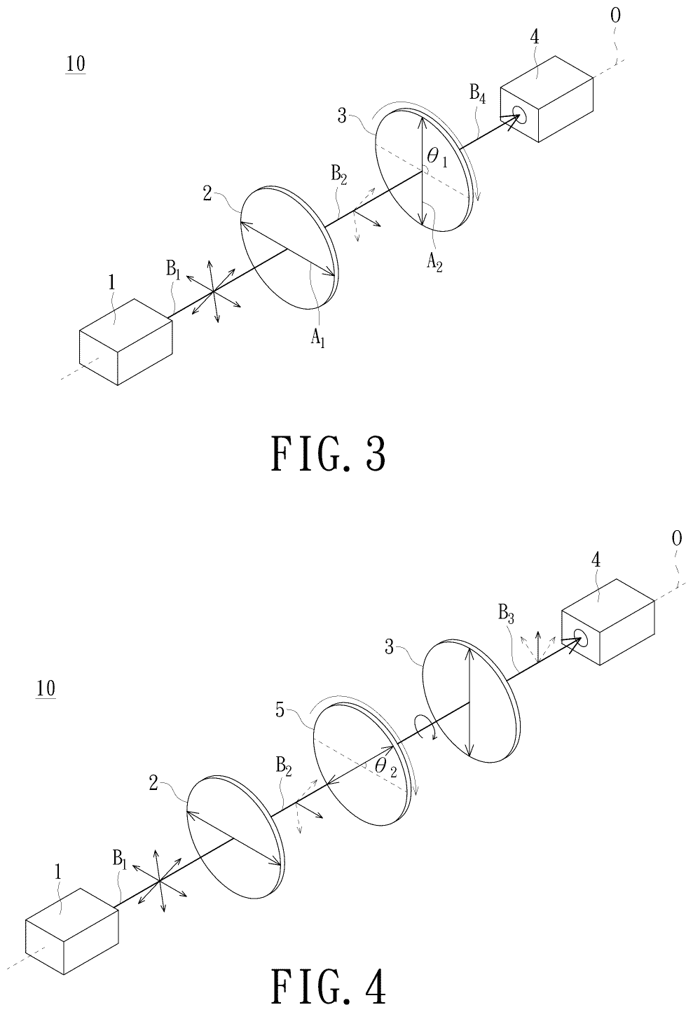

FIG. 3 is a correcting schematic diagram of the optical alignment detection method in an embodiment of the present invention. Based on the above, prior to disposing the wave plate to be detected 5, the optical alignment detection apparatus 10 can be corrected and aligned sequentially. As shown in FIG. 3, the first linear polarizer 2 and the second linear polarizer 3 are disposed opposite to each other. The beam B₁ projected by the light source system 1 is transmitted to the first linear polarizer 2, the beam B₁ is converted into the linearly polarized light beam B₂ by the first linear polarizer 2, and the linearly polarized light beam B₂ is then converted into a corrected beam B₄ by the second linear polarizer 3. The second linear polarizer 3 rotates by taking the center axis O as the axis, and with rotation of the second linear polarizer 3, the optical detector 4 receives the corrected beam B₄, and records and analyzes the intensity of the corrected beam B₄.

In an embodiment, with rotation of the second linear polarizer 3 a circle, the intensity of the corrected beam B₄ has the periodical change, and the periodically changed intensity has a maximum value and a minimum value. For example, the intensity of the corrected beam B₄ is the minimum value, indicating that the included angle θ₁ between the first transmission axis A₁ of the first linear polarizer 2 and the second transmission axis A₂ of the second linear polarizer 3 is 90 degrees or 270 degrees. As shown in FIG. 3, because the first transmission axis A₁ of the first linear polarizer 2 and the second transmission axis A₂ of the second linear polarizer 3 are orthogonal, the intensity of the corrected beam B₄ is the minimum value in the periodical change.

To continue with the above description, according to the recorded intensity of the corrected beam B₄, the angle of the second linear polarizer 3 is confirmed when the intensity of the corrected beam B₄ is the maximum value or the minimum value. The second linear polarizer 3 at the angle is located at the corrected position. When the wave plate to be detected 5 is subsequently disposed between the first linear polarizer 2 and the second linear polarizer 3, the second linear polarizer 3 needs to be positioned at the corrected position.

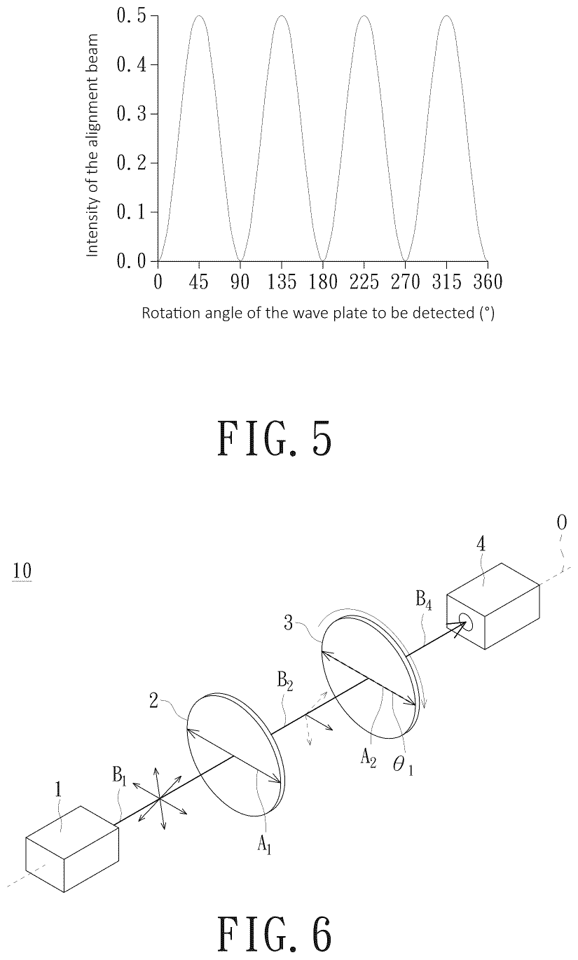

FIG. 4 is an aligning schematic diagram of the optical alignment detection method in an embodiment of the present invention. FIG. 5 is an intensity change diagram of an alignment beam in an alignment process in the optical alignment detection method in an embodiment of the present invention. The corrected position of the second linear polarizer 3 is as shown in FIG. 3 as an example. As shown in FIG. 4, the wave plate to be detected 5 is disposed between the first linear polarizer 2 and the second linear polarizer 3. With rotation of the wave plate to be detected 5 a circle, the optical detector 4 receives the intensity of the alignment beam B₃ and records the periodical change of the intensity of the alignment beam B₃ shown in FIG. 5, and then selects a group of rotation angles according to a relationship between the rotation angles of the wave plate to be detected and the intensity of the alignment beam and rotates the wave plate to be detected 5 to the aligned position. In FIG. 5, the vertical axis is the intensity of the alignment beam and the horizontal axis is the rotation angle of the wave plate to be detected. The intensity of the alignment beam B₃ is a result of normalization. The minimum value of the intensity of the alignment beam B₃ is set as 0, and the maximum value thereof is set as 0.5. Assuming that the minimum value is taken as an initial rotation position of the wave plate to be detected 5, with rotation of the wave plate to be detected 5 a circle, the change of the intensity of the alignment beam B₃ is recorded, which meets the following equation (I). B is the included angle between the fast axis of the wave plate to be detected and the horizontal direction of the apparatus and y is the included angle between the transmission axis of the second linear polarizer and the horizontal direction of the apparatus.

$$I = \frac{1}{4} ( 1 - cos ( 4 β - 4 γ ) ) \qquad Equation ( I )$$

Because the first transmission axis A₁ of the first linear polarizer 2 and the second transmission axis A₂ of the second linear polarizer 3 are orthogonal, the wave plate to be detected 5 rotates till the intensity of the alignment beam B₃ is the maximum value, indicating that the included angle θ₂ between the fast axis of the wave plate to be detected 5 and the second transmission axis A₂ of the second linear polarizer is one of 45 degrees, 135 degrees, 225 degrees or 315 degrees. In this case, the wave plate to be detected 5 and the second linear polarizer 3 can be attached to form the circular polarizer.

FIG. 6 is a correcting schematic diagram of an optical alignment detection method in another embodiment of the present invention. The difference from the embodiment shown in FIG. 3 is that when the correcting step is performed, the rotation angle of the second linear polarizer 3 when the intensity of the corrected beam B₄ is the maximum value is selected as the corrected position of the second linear polarizer 3, indicating that the included angle θ₁ between the first transmission axis of the first linear polarizer 2 and the second transmission axis of the second linear polarizer 3 is 0 degrees or 180 degrees. As shown in FIG. 6, because the first transmission axis A₁ of the first linear polarizer 2 and the second transmission axis A₂ of the second linear polarizer 3 are parallel, the intensity of the corrected beam B₄ is the maximum value in the periodical change.

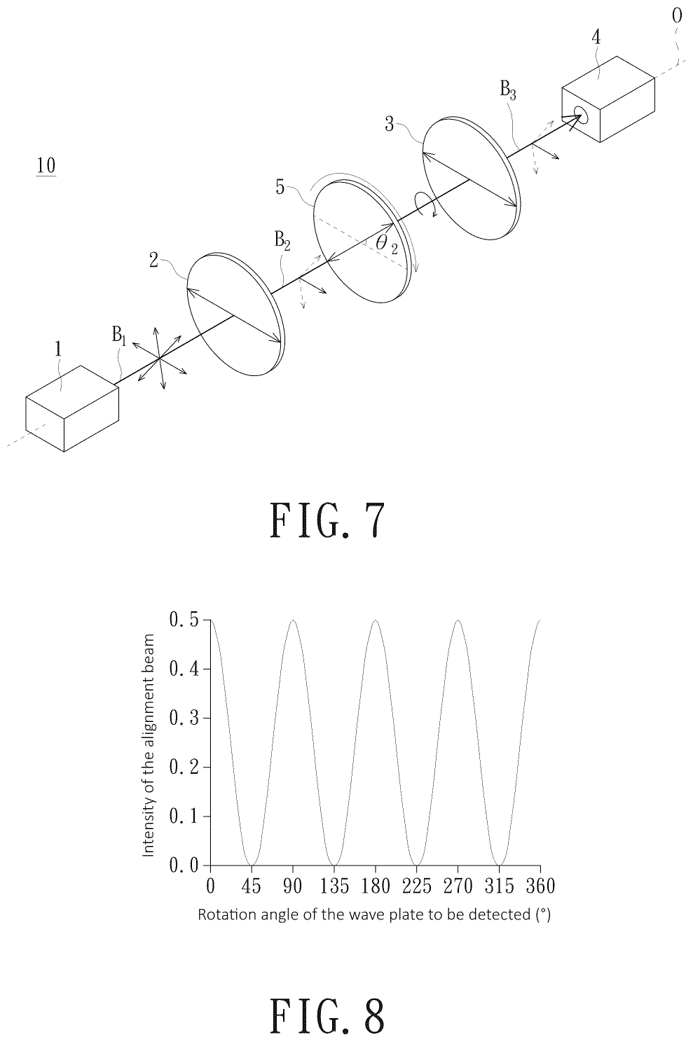

FIG. 7 is an aligning schematic diagram of the optical alignment detection method in another embodiment of the present invention. FIG. 8 is an intensity change diagram of an alignment beam in an alignment process in the optical alignment detection method in another embodiment of the present invention. The corrected position of the second linear polarizer 3 is as shown in FIG. 6 as an example. As shown in FIG. 7, the wave plate to be detected 5 is disposed between the first linear polarizer 2 and the second linear polarizer 3. Assuming that the maximum value of the intensity of the alignment beam B₃ is taken as the initial rotation position of the wave plate to be detected 5, with rotation of the wave plate to be detected 5 a circle, the optical detector 4 receives the intensity of the alignment beam B₃ and records the periodical change of the intensity of the alignment beam B₃ shown in FIG. 8, which meets the following equation (II). B is the included angle between the fast axis of the wave plate to be detected and the horizontal direction of the apparatus and y is the included angle between the transmission axis of the second linear polarizer and the horizontal direction of the apparatus.

$$I = \frac{1}{4} ( 1 + cos ( 4 β - 4 γ ) ) \qquad Equation ( II )$$

Because the first transmission axis A₁ of the first linear polarizer 2 and the second transmission axis A₂ of the second linear polarizer 3 are parallel, the wave plate to be detected 5 rotates till the intensity of the alignment beam B₃ is the minimum value, indicating that the included angle θ₂ between the fast axis of the wave plate to be detected 5 and the second transmission axis A₂ of the second linear polarizer 3 is one of 45 degrees, 135 degrees, 225 degrees or 315 degrees. In this case, the wave plate to be detected 5 and the second linear polarizer 3 can be attached to form the circular polarizer.

Based on the above description, the “alignment” in the specification indicates that the included angle θ₂ between the fast axis of the wave plate to be detected 5 and the second transmission axis A₂ of the second linear polarizer 3 is one of 45 degrees, 135 degrees, 225 degrees or 315 degrees. It is intended to make the wave plate to be detected 5 finally located at the aligned position and the second linear polarizer 3 be further attached to form the circular polarizer.

It can be known from FIG. 5 and FIG. 8 that the optical alignment detection method in the embodiment of the present invention aligns the wave plate to be detected with the corrected second linear polarizer by using the linearly polarized light, and the intensity of the alignment beam can form four periodical waves with rotation of the wave plate to be detected a circle. Compared with conventional optical alignment by using elliptically polarized light or circularly polarized light with only two periodical waves, the optical alignment detection apparatus in the embodiment of the present invention can provide a more precise alignment method as the sensitivity during alignment is improved, so that the circular polarizer formed by attaching the wave plate to be detected and the linear polarizer is more excellent in quality.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical alignment detection apparatus, adapted to detect a wave plate to be detected, the optical alignment detection apparatus comprising:
a light source system, adapted to project a beam;
a first linear polarizer, disposed on a side of the light source system and located on a transmission path of the beam, the beam being converted into linearly polarized light by the first linear polarizer;
a second linear polarizer, disposed on a side of the first linear polarizer away from the light source system, the wave plate to be detected being adapted to be rotatably disposed between the first linear polarizer and the second linear polarizer, wherein the linearly polarized light is transmitted to the wave plate to be detected and the second linear polarizer and is converted into an alignment beam; and
an optical detector, disposed on a side of the second linear polarizer away from the first linear polarizer, the optical detector being adapted to receive the alignment beam and to record and analyze an intensity of the alignment beam.

2. The optical alignment detection apparatus according to claim 1, wherein the beam is a laser.

3. The optical alignment detection apparatus according to claim 1, wherein the optical detector has a polarization interference dephasing system.

4. The optical alignment detection apparatus according to claim 1, wherein the wave plate to be detected rotates by taking a center axis as an axis, and the center axis passes through and is perpendicular to the first linear polarizer and the second linear polarizer.

5. An optical alignment detection method, adapted to detect a wave plate to be detected, the optical alignment detection method comprising:
projecting a beam by using a light source system;
disposing a first linear polarizer on a side of the light source system and converting the beam into linearly polarized light by the first linear polarizer;
disposing a second linear polarizer on a side of the first linear polarizer away from the light source system, the wave plate to be detected being adapted to be rotatably disposed between the first linear polarizer and the second linear polarizer, wherein the linearly polarized light is transmitted to the wave plate to be detected and the second linear polarizer and is converted into an alignment beam, and the alignment beam has different intensities as the wave plate to be detected is located at different rotation angles; and
disposing an optical detector on a side of the second linear polarizer away from the first linear polarizer, receiving the alignment beam by the optical detector and recording and analyzing the intensities of the alignment beam when the wave plate to be detected is located at different rotation angles, wherein when the intensity of the alignment beam is a maximum value or a minimum value, the wave plate to be detected at the rotation angle is located at an aligned position.

6. The optical alignment detection method according to claim 5, wherein the wave plate to be detected is a quarter-wave plate.

7. The optical alignment detection method according to claim 5, wherein the wave plate to be detected rotates by taking a center axis as an axis, and the center axis passes through and is perpendicular to the first linear polarizer and the second linear polarizer.

8. The optical alignment detection method according to claim 5, wherein prior to disposing the wave plate to be detected between the first linear polarizer and the second linear polarizer, the method further comprises a correcting step, the correcting step comprising:
projecting the beam by using the light source system, the beam being transmitted to the first linear polarizer and the second linear polarizer in order and converted into a correction beam, wherein the second linear polarizer rotates by taking the center axis as an axis and the correction beam has different intensities as the rotation angles of the second linear polarizer are different; and
receiving, by the optical detector, the correction beam, and recording and analyzing, by the optical detector, the intensities of the correction beam when the second linear polarizer is located at different rotation angles, wherein when the intensity of the correction beam is a maximum value or a minimum value, the second linear polarizer at the rotation angle is located at a corrected position.

9. The optical alignment detection method according to claim 8, wherein when the wave plate to be detected is disposed between the first linear polarizer and the second linear polarizer, the second linear polarizer is positioned at the corrected position.

10. The optical alignment detection method according to claim 8, wherein the first linear polarizer has a first transmission axis, the second linear polarizer has a second transmission axis, and the correcting step refers to rotating the second linear polarizer to make an included angle between the first transmission axis and the second transmission axis be 0 degrees or 90 degrees.

11. The optical alignment detection method according to claim 10, wherein the wave plate to be detected has a fast axis; and when the intensity of the alignment beam is the maximum value or the minimum value, an included angle between the fast axis of the wave plate to be detected and the second transmission axis is one of 45 degrees, 135 degrees, 225 degrees or 315 degrees.
